(19) United States
(12) Patent Application Publication
(10) Pub. No.: US 2014/0049390 A1
(43) Pub. Date: Feb. 20, 2014

(54) Telenostics point of performance pre-operations condition capture system

(71) Applicants: Ronald E. Wagner, Fleming Island, FL (US); Robert Charlton, Fredericksburg, VA (US); Robert Ufford, Roswell, GA (US)

(72) Inventors: Ronald E. Wagner, Fleming Island, FL (US); Robert Charlton, Fredericksburg, VA (US); Robert Ufford, Roswell, GA (US)

(21) Appl. No.: 12/807,920

(22) Filed: Sep. 16, 2010

Related U.S. Application Data
(60) Provisional application No. 61/342,091, filed on Apr. 9, 2010.

(51) Int. Cl. G08B 1/08

(52) U.S. Cl. 340/539.13; 340/539.11

(57) ABSTRACT

For fleet maintenance a point of performance pre-operations condition capture system includes the use of RFID tags and associated sensors positioned at various vehicle locations to sense operating conditions at the vehicle, with the pre-operations condition provided by a scanner that scans the RFID tags for ascertaining the identity of a sensor and the sensed operational state, such that pre-operations condition can be ascertained and verified due to the RFID tag scanning.

### RELATED APPLICATIONS

This Application claims rights under 35 USC §119(e) from U.S. Application Ser. No. 61/342,091 filed Apr. 9, 2010, the contents of which are incorporated herein by reference.

### FIELD OF THE INVENTION

This invention relates to fleet maintenance and more particularly to a point of performance pre-operations condition capture system.

### BACKGROUND OF THE INVENTION

In commercial fleet operations, maintenance and management activities require an accurate assessment and analysis of vehicle maintenance status that can only be provided by an operator. As will be appreciated, vehicle operators have historically been asked to check their vehicles prior to operation. The vehicle check is completed verbally and more formally by completing a checklist and notifying a supervisor or maintenance technician. However, this process has been inadequate at best and has resulted in exacerbated vehicle maintenance problems because the problems were not brought to the attention of the maintenance office in their infancy, but rather after the problem has worsened to the point of downgrading the operation of the vehicle.

The operators preventive maintenance check conducted via visual inspection must capture the vehicle condition accurately, descriptively and above all routinely, namely each time the vehicle is operated. Furthermore, a pre-operation check needs to be simple to perform, portray the vehicle's condition, and depict enough information for the maintenance technician to make an assessment.

### SUMMARY OF INVENTION

A point of performance pre-operations condition capture system solves a problem by providing an electronic, touchless and visual inspection technique that can be performed by the operator quickly, accurately and descriptively prior to each time the vehicle is operated. The system solves the problem of missing, inaccurate, incomplete and untimely vehicle condition checklists. In order to accomplish the inspection, the subject system utilizes RFID tags, miniaturized scanner technology and wireless connectivity to provide the operator with a palm-sized scanning device and in one embodiment one of three different levels of alert is transmitted after a vehicle inspection. Moreover, visual evidence of capturing the true vehicle condition is included.

The subject performance pre-operations condition capture system collects pre-operation vehicle condition information and transmits it to a dynamic data center which analyzes the information and transmits it to maintenance managers, supervisors or shop foreman for action.

This system may be used in conjunction with the In Service Support Center (ISSC) system described in U.S. patent application Ser. No. 12/660,204 by Richard Dickson filed on Feb. 23, 2010, assigned to the assignee hereof and incorporated herein by reference.

It is noted that the above ISSC system supervises the overall initial gathering of data that is turned into information, transformed into knowledge, and delivered as performance recommendations.

The precondition data feeds the maintenance management engine via telematics, and assists in diagnostics and prognostics, with the diagnostics and prognostics being performed for example by the system described in U.S. patent application Ser. No. 12/548,683 by Carolyn Spier filed on Aug. 27, 2009, assigned to the assignee hereof and incorporated herein by reference.

The pre-operation condition capture improves reliability centered maintenance, event-based maintenance, and condition-based logistics because the start of small maintenance issues are identified, analyzed and acted upon in a speedy, efficient and accurate way, thus to avoid more serious incidents later. Thus, the pre-operations condition capture not only improves efficiency, it enhances safety for the operator and the motoring public, and reduces required resources to maintain a level of service.

In summary, for fleet maintenance a point of performance pre-operations condition capture system includes the use of RFID tags and associated sensors positioned at various vehicle locations to sense operating conditions at the vehicle, with the pre-operations condition provided by a scanner that scans the RFID tags for ascertaining the identity of a sensor and the sensed operational state, such that pre-operations condition can be ascertained and verified due to the RFID tag scanning.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the pre-operation condition capture exercised by an individual carrying a scanning device which is utilized to scan RFID tags and sensors about a vehicle and to provide the information from the sensors wirelessly through a wireless network and the internet to a maintenance data center where diagnostics and prognostics algorithms are utilized to provide a fitness alert; and,

FIG. 2 is a diagrammatic illustration of tag displays which change color depending on the alert level of a monitored condition.

### DETAILED DESCRIPTION

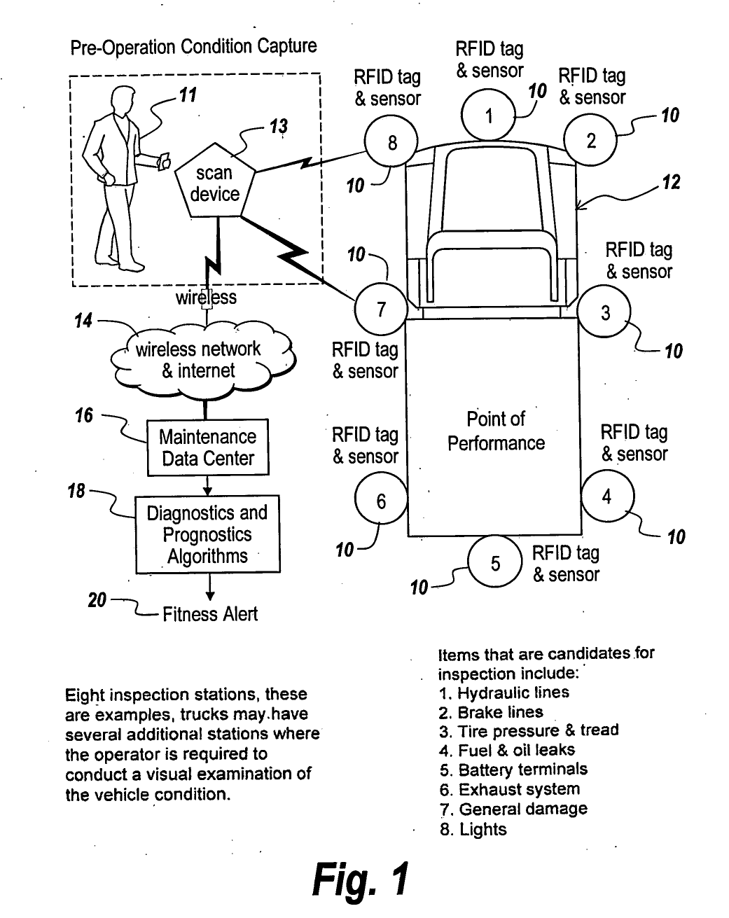

Referring now to FIG. 1, a low cost method to determine the condition of equipment prior to their operation, includes in one embodiment RFID tags 10 having sensors detectable by an individual 11 who is in close proximity to the tag. These tags are placed at various points about a vehicle 12, and are adapted to be scanned by a scanning device 13 carried by individual 12. As indicated by the numbers 1-8, the sensors associated with the individual RFID tags can include sensing the condition of hydraulic lines, brake lines, tire pressure and tread depth, fuel and oil leaks, battery terminal condition, exhaust system condition, general damage and lights. Thus as illustrated at FIG. 1, there may be eight inspection stations. Note, that for certain trucks they may have several additional stations at which the operator is required to conduct a visual examination of vehicle condition.

RFID tags are placed at selected points as illustrated, with each of the RFID tags read out by individual 11 who may be a mechanic or technician so that the condition of the vehicle prior to deployment is readily ascertainable and checkable by a person who has arrived at the vehicle.

The results of the scans of the RFID tag/sensor units are wirelessly connected to a maintenance center 16 via wireless network 14 that is connected to scanning device 13. Diagnostics and prognostics algorithms 18 at maintenance center 16 operate on the information gleaned from the scanned device. The diagnostics and prognostics algorithms are utilized to produce a fitness report 20 to indicate whether the particular vehicle is in adequate condition for operation.

More specifically, the problem for fleet mangers is that they need to have a method for determining the ability of a vehicle or intermodal transport unit to be ready for use or service in the operational environment in which they exist. This has not automatically been provided until the present invention.

The subject system with the RFID solution provides the ability to validate that sensor data has been taken and that data has been processed either by diagnostics or prognostics algorithms. The results of the on-the-spot diagnostic or prognostic process is verified by the fact that an RFID tag has been scanned indicating that an individual has actually visited the site. Note that if a technician arrives at the site and is within range of an RFID tag then it can be concluded that he was at the appropriate location. This verifies the data that is presented to the maintenance center.

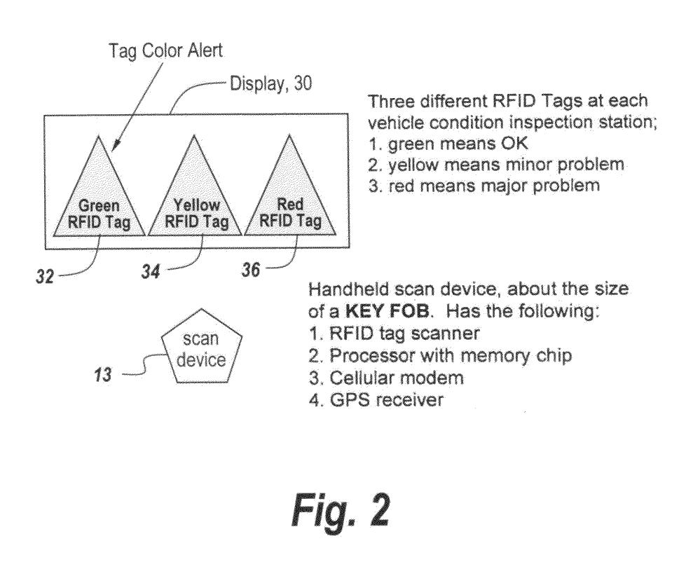

Referring now to FIG. 2, in one embodiment three different RFID tags at each vehicle condition inspection station may provide color alerts as to the particular condition monitored at the station. These color alerts can be recorded by individual 11 as part of the tag scan. For instance, a tag and a sensor 10 may include a display 30 that has a tag color alert level. In this case a green RFID 32 tag indicates that the system is operational, whereas the display of a yellow tag 34 indicates that there may be a minor problem. Finally, the display of a red tag 36 means that a major problem has been sensed at the particular RFID/sensor location.

Note, that scanning device 13 may include a handheld key fob type device which includes an RFID tag scanner, a processor with a memory chip, a cellular modem and a GPS receiver such that the information that is passed via the wireless network to the maintenance data center contains not only the information from the RFID tag, but also processed information which is transmitted in one embodiment utilizing a cellular modem to the center, also indicating the position of the individual 11 who is performing the inspection.

As discussed above, in one embodiment, the operator is provided with a small palm sized device that is carried on a keychain that reminds the driver to check the vehicle, visit and inspect each station, record the condition and finally report it to the supervisor or maintenance facility.

The advantages are three-fold and have a positive multiplier effect on improved maintenance and resource husbandry. First, the information is accurate, trusted and timely. Secondly, the condition information is collected quickly and consistently. Thirdly, the knowledge gained is essential for improving overall maintenance, predicting trends, ordering parts, and planning resource allocations. The multiplier effect is activated when the data is gathered at the point of performance and then remedial action is pushed directly out the point of performance within seconds.

In summary, the capturing of accurate pre-operation vehicle condition information revolutionizes a maintenance repair facility by avoiding situations where symptoms were evident but nobody noticed them or recorded them before the minor symptoms turned into major repair issues.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A method for providing accurate information to fleet maintenance personnel comprising the steps of:
utilizing RFID tags having a processor and associated sensors positioned at a vehicle at different stations to sense operational conditions at the vehicle; each of the sensors having a displayed multi-level visual seriousness alert status driven by the processor and based on the output of an associated sensor; and
scanning the RFID tag displaying a visual seriousness alert with a scanner carried by an individual who is in the proximity of an RFID tag and associated sensor, thereby to ascertain the presence of the individual at the RFID tag and the associated sensor; and,
wirelessly connecting the scanned results to a maintenance center having diagnostics and prognostics algorithms to ascertain from the scanned data an estimate of vehicle fitness and to provide a fitness alert for the operation of the vehicle prior to its deployment, the wirelessly connecting comprising ascertaining the level of alert at a tag and transmitting the level of the alert to the maintenance center.

2. The method of claim 1, wherein each of the RFID tags have a different identifier number which is transmitted back to the RFID scanner carried by the individual, whereby the presence of the individual at a particular RFID tag is ascertainable.

3. The method of claim 2, and further including transmitting the results upon scanning the RFID tag.

4. (canceled)

5. (canceled)

6. The method of claim 1, and further including the step of wirelessly providing the maintenance center with the result of the visual inspection of the multi-level visual alert.

7. The method of claim 1, wherein the transmission of information from an RFID tag at a station includes an electronic touchless inspection system.

8. The method of claim 7, wherein the electronic touchless inspection system includes the step of providing the RFID tags and associated sensors with a visual alert level indicating system and wherein the level of alert at a station is wirelessly communicated to the maintenance center.

9. The method of claim 1, wherein the operational status of the vehicle is captured by the RFID tags having the associated sensors coupled thereto.

10. The method of claim 9, wherein RFID tag and associated sensors provide multi-level alerts with the levels corresponding to the severity of a sensed fault.

11. The method of claim 10, wherein the multi-level alerts include visual alerts.

12. (canceled)

13. (canceled)

14. (canceled)

15. (canceled)

16. (canceled)

17. (canceled)

18. (canceled)

19. (canceled)
